(19) United States
(12) Patent Application Publication
(10) Pub. No.: US 2008/0152727 A1
(43) Pub. Date: Jun. 26, 2008

(54) Aqueous Composition Containing Metal Composition, and Deodorizing Agent, Antibacterial Agent and Antifungal Agent Composed of Such Aqueous Composition

(76) Inventors: Masaaki Yamada, Kyoto (JP); Kazuo Matsumura, Hyogo (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/883,585

(22) PCT Filed: Nov. 29, 2006
(86) PCT No.: PCT/JP06/23859

§ 371 Date: Aug. 1, 2007

(30) Foreign Application Priority Data
Dec. 16, 2005 (JP) 2005-362677
Dec. 16, 2005 (JP) 2005-362678
Jan. 20, 2006 (JP) 2006-011864
Jan. 20, 2006 (JP) 2006-011865
Sep. 19, 2006 (JP) 2006-252338

(51) Int. Cl. A01N 59/16; A01P 3/00; A01P 1/00

(52) U.S. Cl. 424/646

(57) ABSTRACT

The present invention provides an aqueous composition and an aqueous composition comprising a titanium compound, having a deodorant, antimicrobial or antifungal effect. That is, the present invention relates to an aqueous composition comprising a metal composition comprising iron, aluminum and potassium, and water, where the aqueous composition may contain tetrahydroxytitanium hydrochloride, and a deodorant and an antimicrobial and/or antifungal agent comprising the aqueous composition.

### TECHNICAL FIELD

The present invention relates to an aqueous composition comprising a metal composition. Further, it relates to a deodorant composition and an antimicrobial and/or antifungal agent comprising the aqueous composition.

### BACKGROUND ART

Amorphous iron hydrated compounds called ferrihydride extracted from sedimentary rock soils such as basalt and andesite can be a decontamination agent for soils contaminated with heavy metals, and are useful as removal compositions for contamination components by deodorant and antimicrobial functions, which is disclosed in WO 02/078871 pamphlet and Japanese Unexamined Patent Publication Nos. 2004-277382 and 2004-345911.

In WO 02/078871 pamphlet, it is described that ferrihydride is an amorphous iron hydrated oxide represented by a general formula 5Fe₂O₃.9H₂0, and a known substance as ion mineral with a low crystallinity index generally in an early stage of supracrustal formation. Ferrihydride is extracted as an acid soluble component from sedimentary rock soils by sulfuric acid to produce a product (product name “Clay Extract W.W”), which contains iron at a high concentration of 7000-13000 ppm as disclosed. Further, there is disclosed a decontamination method of contaminated soils capable of preventing heavy metals and harmful organic compounds contained in contaminated soils from moving into soils by using ferrihydride humus complexes comprising ferrihydride and organic substances.

Japanese Unexamined Patent Publication No. 2004-277382 discloses a composition for eliminating contamination components, having deodorant and antimicrobial functions based on extract obtained by acid extraction of sedimentary rock soils as an effective component. It is disclosed that metal components of the above-described extract include iron as a main component, silicon, manganese, titanium, magnesium and calcium; the iron content in a concentrate solution for eliminating contamination components is at least 7000 ppm; the sum of magnesium and calcium is less than 30% by weight of the iron content; preferable compositions of sodium, potassium, magnesium and titanium are at least 0.3% by weight and at most 0.5% by weight, at least 0.7% by weight and at most 1.0% by weight, at least 1.0% by weight and at most 1.5% by weight, and at least 0.1% by weight and at most 0.5% by weight to the ion content, respectively. It is also disclosed that the composition for eliminating contamination components shows the maximum deodorant activity at a concentration of at least 1500 times dilution of a concentrate solution for eliminating contamination components (corresponding to 10 ppm of ion content), and shows an antimicrobial effect on methicillin-resistant Staphylococcus aureus (MRSA) at a concentration of 100 times dilution. Further, it is disclosed that function of ferrihydride for eliminating contamination components is strengthened by adding sodium chloride, and the function for eliminating contamination components can be continuously exhibited by adding an organic acid like citric acid. Namely, it is disclosed that addition of organic acid to ferrihydride is necessary to exhibit functions for eliminating contamination components such as deodorant and antimicrobial functions continuously.

In Japanese Unexamined Patent Publication No. 2004-345911, being different from the ferrihydride disclosed in WO 02/078871 pamphlet and Japanese Unexamined Patent Publication No. 2004-277382, a paramagnetic ferrihydride with an extremely low crystallinity index is extracted from an amorphous paramagnetic needle iron ore. It is disclosed that this ferrihydride has various superior functions to, being a different ferrihydride from, the ferrihydride disclosed in WO 02/078871 pamphlet and Japanese Unexamined Patent Publication No. 2004-277382.

As disclosed in WO 02/078871 pamphlet and Japanese Unexamined Patent Publication Nos. 2004-277382 and 2004-345911, by setting extraction conditions from soils, ferrihydrides with differences in structure of iron hydrated oxide, composition ratio and function are being produced. This indicates that the name of ferrihydride is used collectively as compositions comprising iron compounds derived from soils and is not a name given for a single substance having a specific structure.

Regarding the structure of iron hydrated oxide composing ferrihydride, a plurality of structures are disclosed; in WO 02/078871 pamphlet and Japanese Unexamined Patent Publication No. 2004-277382, it is disclosed that depending on pH conditions, it takes different presence forms such as Fe³⁺, Fe(OH)²⁺, Fe(OH)₂⁺, and Fe (OH)₃, in Japanese Unexamined Patent Publication No. 2004-345911, the structure of ferrihydride is described as 5Fe₂O₃.9H₂O, Fe₅HO₃.4H₂O, Fe₄(O₄H₃)₃ or Fe₂O₃±2FeOOH 2.6H₂O.

Further, as a mechanism for exhibiting deodorant and antimicrobial functions of ferrihydride, it is disclosed only on the basis of unusual properties of ferrihydride in any WO 02/078871 pamphlet and Japanese Unexamined Patent Publication Nos. 2004-277382 and 2004-345911. Namely, in WO 02/078871 pamphlet, it is disclosed that ferrihydride has such properties that an OH group having unusual charge characteristics on its surface absorbs heavy metals having a positive ion and makes a chelate bond into their fixation and inactivation; it agglutinates through a chelate bond with a functional group having a negative charge of organic compounds; and it absorbs and decomposes organic compounds and inactivates them by a property of iron hydrated oxide catalyzing decomposition of organic compounds, which can decontaminate soils containing organic compounds.

In Japanese Unexamined Patent Publication No. 2004-277382, it is inferred to exhibit various functions for decomposing contamination components in such a way that Fe³⁺ capable of generating secondary oxides such as ferrihydride is contained, Fe³⁺ is changed to Fe²⁺ upon generating ferrihydride to oxidize other substances. Further, it is disclosed that ferrihydride is assumed to have a high ability for collecting, fixing, eliminating and decomposing contamination components by its property of forming aggregates with organic compounds.

In Japanese Unexamined Patent Publication No. 2004-345911, it is disclosed that an important element is how much paramagnetic iron ions there are, and a principle of deodorant power of ferrihydride is decomposition by releasing oxygen that ferrihydride is coordinated, which is thought to be related to a catalytic effect of ferrihydride.

As described above, in any WO 02/078871 pamphlet and Japanese Unexamined Patent Publication Nos. 2004-277382 and 2004-345911, there is never mentioned the importance of existence of metals other than ferrihydride.

Further, as antimicrobial and sterilization treatments for textile goods etc., utilization of titanium compounds having antimicrobial activity is disclosed: a titanium phosphate antimicrobial agent is disclosed in Japanese Unexamined Patent Publication No. 6-212562, and an antimicrobial rubber article comprising a titanium phosphate antimicrobial agent is disclosed in Japanese Unexamined Patent Publication No. 9-157449. Japanese Unexamined Patent Publication No. 2002-308721 also discloses an antimicrobial agent, deodorant or fungicide having a titanium phosphate compound as an effective component being expressed by a general formula: [Ti(OH)ₓ(PO₄)_{y}(HPO₄)_{z}(H₂PO₄)ₗ(OR)ₘ] wherein R is an alkyl group with carbon atoms of 1-4, x, y, z, 1 and m are each at least 0, satisfying x+3y+2z+1+m=4. As expressed by the general formula, the name of titanium phosphate compound is used collectively as a plurality of compounds. However, there is not concretely specified the structure of titanium phosphate compound having an antimicrobial, deodorant or fungicidal effect. Namely, there is utterly no disclosure whether all compounds expressed by the general formula have the above described effect, or only a part of the compounds have the above described effect.

### DISCLOSURE OF INVENTION

An object of the present invention is to provide a composition capable of exhibiting high deodorant, antimicrobial and antifungal effects continuously.

The present inventors have keenly studied on action mechanisms exhibiting deodorant, antimicrobial and antifungal effects of aqueous compositions comprising a metal composition and water. As a result, they have found that it is very important for the aqueous compositions to contain not only iron but also metal components other than iron, and proposed an action mechanism described later. Based on the action mechanism, they have specified the metal components necessary to exhibit the effects (hereinafter, referred to as “essential metal components”), confirmed the contents of essential metal components, controlled the contents in a given range by composing the essential metal components, thereby to be able to produce an aqueous composition comprising a metal composition having a certain quality, and completed the present invention.

Namely, the present invention relates to an aqueous composition comprising a metal composition comprising iron, aluminum and potassium as essential metal components, and water.

In the above-described aqueous composition, it is preferable that the contents of aluminum and potassium are 100-300 ppm and 1-20 ppm, respectively, relative to 100 ppm of iron.

The present invention also relates to the aqueous composition comprising, a metal composition comprising iron, aluminum and potassium, a composition that tetrahydroxytitanium hydrochloride is composed to the metal composition, and water.

It also relates to a deodorant composition comprising the above-described aqueous composition.

It further relates to an antimicrobial agent comprising the above-described aqueous composition.

It furthermore relates to a antifungal agent comprising the above-described aqueous composition.

### BRIEF DESCRIPTION OF DRAWINGS

FIG. 1 is a figure showing the ammonia deodorizing activity of the aqueous composition of the present invention in terms of ammonia concentration against time elapsed.

FIG. 2 is a figure showing the hydrogen sulfide deodorizing activity of the aqueous composition of the present invention in terms of hydrogen sulfide concentration against time elapsed.

FIG. 3 is a figure showing the acetic acid deodorizing activity of the aqueous composition of the present invention in terms of acetic acid concentration against time elapsed.

FIG. 4 is a figure showing the acetaldehyde deodorizing activity of the aqueous composition of the present invention in terms of acetaldehyde concentration against time elapsed.

FIG. 5 is a figure showing the formaldehyde deodorizing activity of the aqueous composition of the present invention in terms of formaldehyde concentration against time elapsed.

### BEST MODE FOR CARRYING OUT THE INVENTION

Aluminum, iron and potassium are essential metal components to exhibit deodorant, antimicrobial and antifungal effects by a metal composition proposed by the present inventors.

Additionally, as a composition comprising essential metal components used in the present invention (hereinafter, referred to as “metal composition”), it is possible to use an extract derived from soil containing a plurality of metals.

As the metal composition used in the present invention, it is possible to use a composition comprising iron, aluminum and potassium extracted from soils. For example, it can be obtained by extraction with inorganic acids from red-yellow soils including iron ore. In the case of sulfuric acid extraction, soils are added to 20% by weight of an aqueous sulfuric acid solution heated at 70° C. or more, allowed to stand for at least about 1 day, the resultant soils are removed by a filtration or centrifugal method, neutralized if necessary, thereby to give a mixture of metal compounds derived from soil as an acid-soluble component.

The aqueous composition of the present invention can be produced by diluting the metal composition with water into a suitable concentration.

The deodorant, antimicrobial and antifungal effects of the present invention can be theorized by the following action mechanism.

It is a known fact that in potassium with mass number of 39 (hereinafter, referred to as ³⁹K), a trace of unstable potassium of mass number of 40 (hereinafter, referred to as ⁴⁰K) is mixed. This ⁴⁰K is an energy source to exhibit the deodorant, antimicrobial and antifungal effects of the metal composition used in the present invention. Namely, an unstable ⁴⁰K emits an excessive energy as an electron beam or electromagnetic wave to convert itself into a stable element. Further, the electron beam collides against metal atoms in the metal composition to release a secondary electromagnetic wave (also called bremsstrahlung X-ray). The electron beam, electromagnetic wave and secondary electromagnetic wave emitted by ⁴⁰K collide against water molecules in the air to generate hydrated electron (e⁻), atomic hydrogen (—H), hydrogen gas (H₂), hydroxyl radical (.OH), and hydrogen peroxide (H₂O₂). The hydrated electron and atomic hydrogen generated are oxidized with oxygen in the air to generate hydroperoxyl radical (.OOH) and superoxide ion (O₂⁻), respectively. Further, the hydroperoxyl radical binds with the atomic hydrogen to generate hydrogen peroxide.

The hydrogen peroxide generated in these reactions is reduced by iron, a transition element in the metal composition used in the present invention to generate hydroxyl radical and hydroxide ion (OH⁻). This reaction is called Fenton reaction. Further, hydrogen peroxide is oxidized by a transition element to generate a hydroperoxyl radical and hydrogen ion (H⁺).

The hydroxyl radical and superoxide ion are generated by a chain reaction starting from such energy emission of ⁴⁰K. Further, the superoxide ion is a precursor of hydrogen peroxide, and then hydroxyl radical is generated from hydrogen peroxide as described above. It is thought that the hydroxyl radical and superoxide ion having an oxidizing power exhibit a deodorant effect decomposing chemical substances and volatile organic compounds, bacteriostasis and bacterial killing effects inhibiting the growth of microbe.

Iron is a typical transition element that is thought to be involved in Fenton reaction generating a hydroxyl radical and hydroxide ion from the foregoing hydrogen peroxide and in an oxidation reaction generating a hydroperoxyl radical and hydrogen ion. As transition elements in the metal composition of the present invention, there are listed iron, manganese, titanium, vanadium, cobalt, cerium, copper, yttrium and lanthanum.

Aluminum plays a role as a binder in the case where a metal composition used in the present invention is sprayed and fixated on a physical object like wall surface in an application of deodorant for example. Namely, it is present in a water-soluble aluminum compound such as aluminum sulfate in the above-described metal composition, when it is sprayed on a physical object, by drying, changed to a water-insoluble aluminum oxide to form a porous thin membrane on the physical object, thereby to fixate essential metal components like iron onto the physical object. It is possible to exhibit the deodorant, antimicrobial and antifungal effects continuously by the fixation of essential components through this aluminum membrane.

The contents of iron, aluminum and potassium as the essential metal components of the present invention relative to 100 ppm of iron are preferably 100-300 ppm and 1-20 ppm, respectively. More preferably, aluminum is at most 200 ppm relative to 100 ppm of iron, may be at most 150 ppm. The content of potassium is preferably 1-10 ppm relative to 100 ppm of iron. As other metals, calcium, magnesium, manganese, copper, silicon, phosphor and zinc are contained, those are very effective to generate the above-described secondary electromagnetic wave by an electron beam emitted by ⁴⁰K, and are thought to be contributed to exhibition of the effects.

Further, in the present invention, it is preferable to compose tetrahydroxytitanium hydrochloride in the above-described aqueous composition. Tetrahydroxytitanium hydrochloride is the hydrochloride of hydroxytitanium that 4 residues of hydroxyl group (OH group) are bonded to a titanium, and is a titanium compound which easily solves in water. Since tetrahydroxytitanium itself has a poor solubility to water, it is not suitable in use as an effective component for a deodorant and an antimicrobial and/or antifungal agent. Taking into consideration the ease of preparation for spray liquid and adjustment of concentration, preferable is a salt of tetrahydroxytitanium such as hydrochloride providing a water-soluble characteristic. Further, as hydrochlorides, monohydrochloride, dihydrochloride, trihydrochloride and tetrahydrochloride compounds are listed. As the tetrahydroxytitanium hydrochloride, tetrahydroxytitanium monohydrochloride and tetrahydroxytitanium dihydrochloride are specifically listed.

In the case of using at least 2 kinds of tetrahydroxytitanium hydrochlorides, the combination is not particularly limited, and the effects described later can be exhibited in any combination. By composing these titanium compounds into a metal composition of the present invention, titanium-composed composition can be produced, which enhances the deodorant, antimicrobial and antifungal effects of the aqueous composition of the present invention.

For example, tetrahydroxytitanium hydrochloride can be obtained by a reaction of titanium tetrachloride with aqueous isopropyl alcohol. More precisely, aqueous solution of tetrahydroxytitanium hydrochloride can be obtained by removing free hydrochloric acid from a clear solution obtained such that 50% isopropanol aqueous solution was added dropwise in a titanium tetrachloride solution. The solution is concentrated to dryness to obtain tetrahydroxytitanium hydrochloride of white powder.

The composition amount of titanium in the aqueous composition of the present invention is preferably 0.2-50 ppm as the final concentration relative to 100 ppm of iron, more preferably 0.5-20 ppm.

The deodorant, antimicrobial and antifungal effects by the aqueous composition of the present invention is based on the schema in which hydroxyl radial and hydrogen peroxide are generated from water molecules in the air by ⁴⁰K as an energy source as described above, further, from the hydrogen peroxide generated, hydroxyl radical is generated by reduction reaction with transition elements such as iron and titanium. It is thought that the hydroxyl radical and superoxide ion generated from series of these reactions having an oxidizing power exhibit a deodorant effect decomposing chemical substances and volatile organic compounds, bacteriostasis and bacterial killing effects inhibiting the growth of microbe. The action mechanism exhibiting such effects is radically different from the action mechanisms of inventions disclosed in the foregoing WO 02/078871 pamphlet and Japanese Unexamined Patent Publication Nos. 2004-277382 and 2004-345911, namely, by unusual charge characteristics of the surface of ferrihydride being an iron hydrated compound, ferrihydride has properties that it absorbs heavy metals and makes a chelate bond into their fixation and inactivation, thereby decontaminates soils containing organic compounds (see the foregoing WO 02/078871 pamphlet); Fe³⁺ is changed to Fe²⁺ in ferrihydride to oxidize other substances and exhibit various functions for decomposing contamination components (see the foregoing Japanese Unexamined Patent Publication No. 2004-277382); or a principle of deodorant power of ferrihydride is decomposition by releasing oxygen that ferrihydride is coordinated, which is related to a catalytic effect of ferrihydride (see the foregoing Japanese Unexamined Patent Publication No. 2004-345911).

In the aqueous composition of the present invention, it becomes possible to supply a product having stable effects by controlling the quality though examining the concentrations of 3 components of iron, aluminum and potassium, or 4 components of iron, aluminum, potassium and titanium. The composition of metal components other than the 3 or 4 components and their concentrations are not particularly limited as long as they do not provide very adverse influences on the qualities and effects of the composition.

As water used in production of the aqueous composition of the present invention, there are listed pure water, ion-exchange water, hard water, soft water or tap water. However, pure water and ion-exchange water are preferred because of avoidance of chemical reaction with metal components in the composition and guarantee of product quality.

The aqueous composition of the present invention can be used as a deodorant and an antimicrobial and/or antifungal agent. In the case where the aqueous composition is used as a deodorant and an antimicrobial and/or antifungal agent, suitable additives ordinarily used can be optionally added, such as aromatic components and drying auxiliaries.

Additionally, the action mechanism for the deodorant, antimicrobial and antifungal effects of the aqueous composition of the present invention is as described above, being different from that of titanium dioxide with photocatalytic activity. Since the aqueous composition of the present invention requires no ultraviolet radiation to exhibit the effects, it can be used inside a room.

The aqueous composition of the present invention can be fixated for use on a physical object by a method such as spray, coating and impregnation. As the physical object, textile goods and wall paper are listed, but it is not particularly limited. Further, as described above, the aqueous composition of the present invention exhibits the effects in dark, thus, the effects can be expected for articles used inside a room.

Regarding the amount used in spray or coating of the aqueous composition of the present invention, depending on the concentration of essential metal components in the aqueous composition, in the case of the aqueous composition where iron concentration is 20±5 ppm, the amount per area applied is preferably 5-20 mL/m², further preferably 8-10 mL/m², and the amount used can be adjusted in accordance with structures in a use place and contamination situations.

The aqueous composition of the present invention can be used widely without regard to the composition of physical object, on inner and outer surfaces aiming at a deodorant and an antimicrobial and/or antifungal agent by spray or coating. Further, even when the aqueous composition of the present invention is blended for use with surface treatment agents such as an antifouling agent, Shinsui Flow (manufactured by Dainippon Shikizai Kogyo Co., Ltd.) for example, the effects of the present invention are not damaged.

The present invention will be described further in detail with reference to concrete Examples below. The following Examples are merely aimed at explanation, and are not intended to limit the condition and technical scope.

### EXAMPLES

### Production Example 1

### Production of Metal Composition

To 5 kg of 20% by weight of an aqueous sulfuric acid solution heated at 80° C., 3 kg of soil finely crushed was added and stirred, and allowed to stand for 24 hours while the container being filled with nitrogen. The fraction of precipitation was removed by filtration to give an acid extract of soil, and then this extract was diluted with water to obtain a metal composition (#1) derived from soil. The same operation was repeated to obtain a metal composition (#2).

Quantitative and semi-quantitative analyses were conducted to determine the kinds and contents of metal elements in the metal composition (#1) and metal composition (#2). The metal composition (#1) was analyzed by an ICP emission spectral analysis (atomic absorption analysis for sodium and potassium) using a sequential model IPC emission spectrophotometer. The metal composition (#2) was analyzed by ICP-MS method using an Agilent 7500c model ICP/MS analyzer. The analysis data are shown in Table 1. The variation of the content was observed lot-to-lot in metal elements of the metal composition derived from soil. Besides the metal elements described in Table 1, there were detected vanadium, zinc, cobalt, cerium, copper, strontium, yttrium, zirconium, gallium, lanthanum, boron, chromium, lithium and silicon.

TABLE 1

| | Content (ppm) | |
|---|---|---|
| Element | Metal composition (#1) | Metal composition (#2) |
| Al (aluminum) | 1000 | 2000 |
| Fe (iron) | 800 | 800 |
| Mg (magnesium) | 50 | 70 |
| Ca (calcium) | 40 | 10 |
| K (potassium) | 9 | 10 |
| Mn (manganese) | 9 | 10 |
| Na (sodium) | 4 | 4 |
| Ti (titanium) | 2 | 3 |

### Production Example 2

### Production of tetrahydroxytitanium hydrochloride

19 g (5.78 mL) of titanium tetrachloride TiCl₄ was added by drops to a mixed solution of 25 mL of isopropyl alcohol and 25 mL of ion-exchanged water, stirred at room temperature for 5 minutes to obtain a clear solution, part of the solution was concentrated by an evaporator at 50° C. to give a syrupy concentrate. This concentrate was diluted by adding ion-exchanged water and concentrated by an evaporator, which was repeated three times to remove hydrochloric acid. The concentrate obtained was diluted with ion-exchange water and frozen-dry, thereby to give white powders. The product was measured for the contents of titanium (Ti) and phosphor (P) by an ICP emission spectral analysis, the contents of carbon (C), hydrogen (H) and nitrogen (N) were measured by an elemental analysis using a fully automatic elemental analyzer, and the content of chlorine (Cl) was measured by a fluorescence X-ray analysis. As a result, the content of titanium was 27.3-27.0% by weight, the content of hydrogen was 3.6% by weight, the content of chlorine was 30% by weight, and phosphor, carbon and nitrogen were not detected. Assuming that the residual element was oxygen (O), the content of oxygen (O) becomes 39.1-39.4% by weight. Since the results of the element content ratio were completely agreed with the theoretical values of element content ratio for tetrahydroxytitanium 1.5 hydrochloride 0.5 hydrate (titanium 27.1% by weight, chlorine 30.0% by weight, hydrogen 3.6% by weight, and oxygen 39.3% by weight), it was concluded that the product was a tetrahydroxytitanum hydrochloride that 4 residues of hydroxyl group were bound with a titanium, and 1 to 2 molecules of hydrochloride were added thereto.

### Example 1

To one part by weight of the metal composition (#1) produced in Production Example 1, 9 parts by weight of ion-exchanged water were added and stirred to obtain a uniform concentrate solution of the aqueous composition. To this concentrate solution of the aqueous composition, equal volume of ion-exchanged water was added to give an aqueous composition.

### Example 2

To the concentrate solution of the aqueous composition produced in Example 1, equal volume of a solution of 100 mg of tetrahydroxytitanum hydrochloride produced in Production Example 2 dissolved in 500 mL of ion-exchange water was added, thereby to obtain an aqueous composition of the metal composition (hereinafter, referred to as “titanium-composed aqueous composition 1”).

### Example 3

To the metal composition (#2) produced in Production Example 1, tetrahydroxytitanum hydrochloride produced in Production Example 2 was added to be 2 mg/L of the final titanium concentration to produce a titanium-composed composition. To one part by weight of this titanium-composed composition, 49 parts by weight of ion-exchanged water were added and stirred, thereby to obtain a uniform aqueous composition (hereinafter, referred to as “titanium-composed aqueous composition 2”).

### <Evaluation Test Method>

### (Production of Sample Fabric)

Sample fabrics (cotton 100%) each were immersed for at least 1 hour in the aqueous composition and the titanium-composed aqueous composition 1 produced in Example 1 and Example 2, respectively. Next, the immersed fabrics were hung down and allowed to dry naturally at room temperature over night or more, which were used as sample fabrics and evaluated for deodorizing (deodorizing activity 1), the antimicrobial and antifungal activity (antifungal effect 1). Regarding the titanium-composed aqueous composition 2 produced in Example 3, the immersed fabrics produced in the same way were used as sample fabrics, and then the antimicrobial and antifungal activity (antifungal effect 2) was evaluated.

### (Production of Sample Tile)

The surface of a porcelain tile (SP model manufactured by INAX Corporation; 100 mm square, flat, 5 mm thick) was wiped with alcohol and dried. Then, using an air compressor (AC 700 model manufactured by Makita Corporation) and a spray gun of air pressure 0.5-0.7 MPa and a nozzle diameter of 0.5 mm (manufactured by Kinki Seisakusho Co., Ltd.), the tile was sprayed with about 2 mL of titanium-composed aqueous composition 2 produced in Production example 3, and dried (hereinafter, referred to as “spray process”), used as a sample tile, and evaluated for deodorizing activity (deodorizing activity 2). In the case where a porcelain tile is used as a test sample, the absorption of formaldehyde causing a sick building syndrome into the test sample is suppressed compared with the case where a fabric is used as a test sample, thus, it is possible to evaluate a formaldehyde deodorizing activity effect of the aqueous composition of the present invention in better conditions.

### (Deodorizing Activity 1)

Test was conducted by a detector tube method using a sample fabric and 5 L Tedlar bag. To a Tedlar bag where a sample fabric (5 cm long, 5 cm wide) cut from the fabric impregnated with the aqueous composition or the titanium-composed aqueous composition 1 was set, ammonia gas was injected at a concentration of 100 ppm. The concentration of ammonia in the bag was measured 24 hours after the gas injection, and deodorizing activity was evaluated by the decreasing degree of ammonia as an index. A control test was carried out using an ion-exchanged water impregnated fabric for a reference of the decrease in ammonia concentration by absorption of ammonia into a sample fabric and natural decrease.

### (Deodorizing Activity 2)

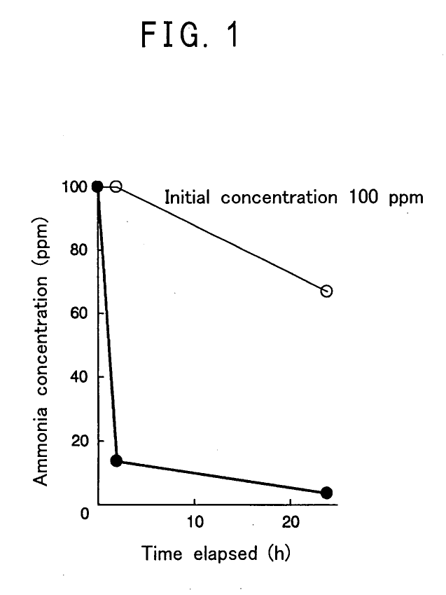

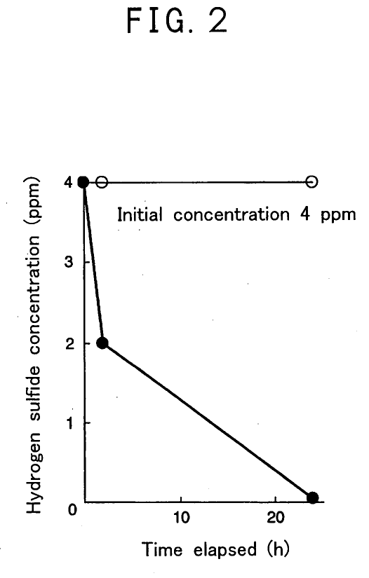

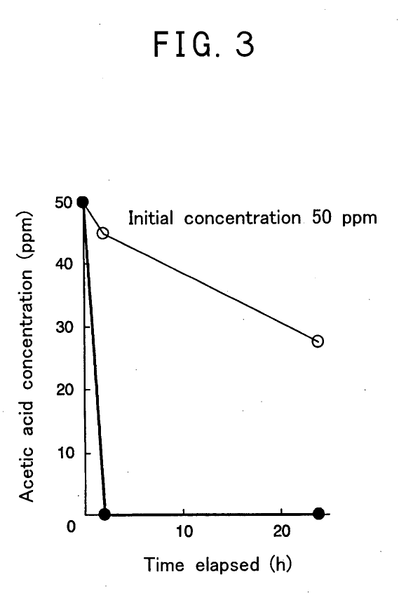

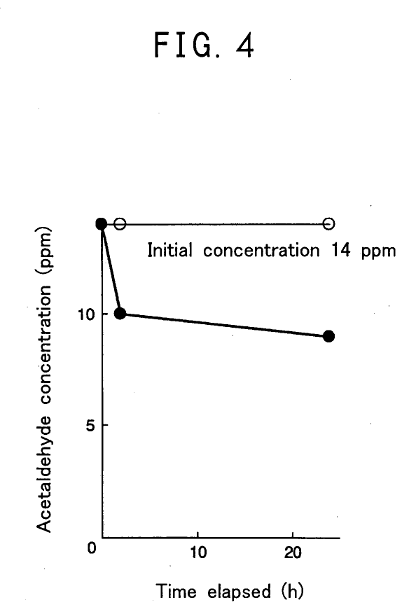

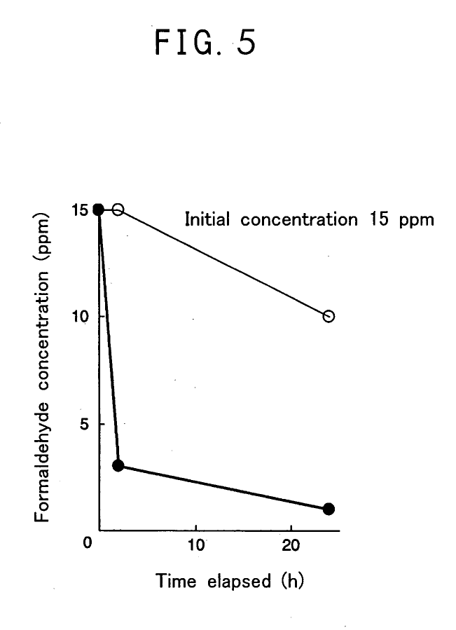

Test was conducted by a detector tube method using a sample tile and 5 L Tedlar bag. The porcelain tile spray-processed with the titanium-composed aqueous composition 2 produced in Production example 3 was placed in a Tedlar bag, and then odor components (ammonia, hydrogen sulfide, acetic acid, acetaldehyde or formaldehyde) were injected therein at the predetermined initial concentrations described in FIGS. 1 through 5. Concentrations of odor components in the bag were measured 2 and 24 hours after the injection of odor components by a detector tube method. At the same time, natural decreasing degree of odor component in a test without placing a test sample (hereinafter, referred to as “blank test”) was measured, comparing with which, the deodorizing effect was evaluated.

### (Antimicrobial Activity)

Antimicrobial activity was evaluated in accordance with Japanese Industrial Standards (JIS) L1902 (antimicrobial test method and antimicrobial effect of textile product). As test bacteria, Staphylococcus aureus (ATCC 6538P) and Escherichia coli (NBRC 3301) were used. A sample fabric cut from the foregoing impregnated fabric and a standard cotton fabric not processed of 0.4 g (18 mm long, 18 mm wide) each were placed in a vial container, wrapped with an aluminum foil, sterilized in an autoclave, then, dried in a clean bench. After drying, the vial container was stoppered tightly with a sterilization cap. In the vial container where this sterilized sample fabric or standard cotton fabric not processed was placed, 0.2 mL of test bacteria suspension prepared in a nutrient medium of 1/20 concentration was inoculated, and cultured at 37±1° C. After incubation for 18 hours, a washing-out liquid was added in the vial container to shake/disperse bacteria, the number of living bacteria in the washing-out liquid was measured by a pour plate cultural method.

The antimicrobial activity was measured as following indexes: the number of bacteria collected after incubation for 18 hours of test bacteria inoculated to a standard cotton fabric not processed, and the number of bacteria collected after incubation for 18 hours of test bacteria inoculated to the sample fabric.

### (Antifungal Effect 1)

Fungus resistance was tested in accordance with Japanese Industrial Standards (JIS) Z2911. As test fungi, Aspergillus niger (ATCC 6275) and Penicillium citrium (ATCC 9849) were used. A sample fabric (50 mm long, 50 mm wide) was sterilized in an autoclave and dried. A mixed spore suspension was sprayed to this sample fabric, and cultured at 28° C. The growth of fungi on the sample fabric was observed at 4, 7, 10 and 14 days of culture period. The antifungal effect was evaluated by the growth process of fungi as an index.

The growth processes were classified into 3 levels: a state observed without growth, a state observed with a slight growth, and a state observed with a definite growth. Regarding the state observed with growth, it was evaluated as 5 levels (1+) to (5+) in growth degrees from a light degree to a maximum remarkable degree.

### (Antifungal Effect 2)

Fungus resistance was tested in accordance with Japanese Industrial Standards (JIS) L1902. As a test fungus, Aspergillus niger (ATCC 6275) was used. A sample fabric (18 mm long, 18 mm wide) was sterilized in an autoclave, then dried in a clean bench, and stoppered tightly with a sterilization cap. A spore suspension of test bacteria was inoculated to this sample fabric, and cultured at 27±1° C. for 18 hours. After incubation, a washing-out liquid was added in the vial container to wash fungi out, the number of living fungi in the washing-out liquid was measured after incubation at 27±±1° C. for 3 days.

### <Evaluation Results on Activities>

### (Evaluation Result on Deodorizing Activity 1)

Since ammonia gas being an odor component is absorbed in a sample fabric and tends to lower the concentration of ammonia in a Tedlar bag, the amount of ammonia absorbed in the sample fabric and the amount of ammonia naturally decreased are eliminated by a test using a reference test fabric. Based on the concentration of ammonia left in the Tedlar bag, the deodorizing activity by the decomposition reaction of the aqueous composition of the present invention was evaluated.

As a result, the lowering of the concentration of ammonia by the decomposition reaction of the aqueous composition of Example 1 was 23 ppm, showing a strong deodorizing activity. The lowering of the concentration of ammonia by the titanium-composed aqueous composition 1 (Example 2) that tetrahydroxytitanium hydrochloride was composed in this aqueous composition was 26 ppm, showing a tendency of increasing a strong deodorizing activity of the aqueous composition.

### (Evaluation Result on Deodorizing Activity 2)

Table 2 shows the results on the deodorizing activity 2 to ammonia, hydrogen sulfide, acetic acid, acetaldehyde or formaldehyde using the porcelain tile spray-processed with the titanium-composed aqueous composition 2 obtained in Example 3. The plots are shown in FIGS. 1 through 5 to make the effects of the present invention clear. In FIGS. 1 through 5, open circles show the concentration in the blank test, and closed circles show the concentration in the presence of the porcelain tile spray-processed with the titanium-composed aqueous composition 2 (Example 3).

As shown in Table 2 and FIGS. 1 through 5, the remarkable decrease in each component for all odor components was observed during the first 2 hours, and further decrease was observed after 24 hours, thereby to confirm that the deodorizing effect was continuously exhibited.

TABLE 2

| | | Titanium-composed | |
|---|---|---|---|
| | Time elapsed | aqueous composition 2 | |
| | (h) | (Example 3) | Blank test |
| Concentration of | 0 | 100 | 100 |
| ammonia (ppm) | 2 | 13.5 | 100 |
| | 24 | 3.8 | 67.0 |
| Concentration of | 0 | 4.0 | 4.0 |
| hydrogen sulfide | 2 | 2.0 | 4.0 |
| (ppm) | 24 | <0.05 | 4.0 |
| Concentration of | 0 | 50.0 | 50.0 |
| acetic acid (ppm) | 2 | 0.1 | 45.0 |
| | 24 | 0.05 | 27.5 |
| Concentration of | 0 | 14.0 | 14.0 |
| acetaldehyde | 2 | 10.0 | 14.0 |
| (ppm) | 24 | 9.0 | 14.0 |
| Concentration of | 0 | 15.0 | 15.0 |
| formaldehyde | 2 | 3.0 | 15.0 |
| (ppm) | 24 | 1.0 | 10.0 |

### (Evaluation Result on Antimicrobial Activity)

When Escherichia coli (2.2×10⁴) were inoculated to a standard cotton fabric not processed, and cultured for 18 hours, they proliferated to 4.7×10⁷. When Staphylococcus aureus (1.6×10⁴) were inoculated and cultured for 18 hours, they proliferated to 1.0×10⁷. In this test condition, when test bacteria were inoculated in the same condition to the impregnated fabrics with the aqueous composition (Example 1) and the titanium-composed aqueous composition 1 (Example 2) and cultured for 18 hours, the number of living bacteria was each at most 20, showing the strongest antimicrobial activity in the present antimicrobial test system. Further, when Escherichia coli (1.7×10⁴) were inoculated to a standard cotton fabric not processed, they proliferated to 3.4×10⁷ after incubation for 18 hours. When Staphylococcus aureus (1.5×10⁴) were inoculated to a standard cotton fabric not processed, they proliferated to 7.6×10⁶ after incubation for 18 hours. In this test condition, when test bacteria were inoculated in the same condition to the impregnated fabrics with the titanium-composed aqueous composition 2 (Example 3) and cultured for 18 hours, the number of living bacteria was each at most 20, indicating that Escherichia coli and Staphylococcus aureus were almost completely sterilized.

### (Evaluation Result on Antifungal Effect 1)

When a mixed spore suspension of Aspergillus niger and Penicillium citrium was sprayed on a standard cotton fabric not processed and cultured at 28° C., a remarkable growth of fungi as evaluation (4+) was observed after incubation for 4 days, and a very remarkable growth of fungi as evaluation (5+) was observed in the incubation periods for 7 days through 14 days. The growth area of fungi at the incubation period for 14 days reached at least ⅓ of the area of the standard cotton fabric not processed. In the sample fabric impregnated with the aqueous composition (Example 1) in this test condition, the growth of fungi after incubation for 4 days was strongly suppressed, where the growth was observed only in a light degree of evaluation (1+). Thereafter, growth of fungi as evaluation (4+) was observed in the incubation periods for 7 days through 14 days, and the growth area of fungi at the incubation period for 14 days reached at least ⅓ of the area of the sample fabric. Further, in the sample fabric impregnated with the titanium-composed aqueous composition 1 (Example 2), the growth of fungi after incubation for 4 days was completely suppressed, and the growth only in a light degree of evaluation (1+) was observed after the incubation for 7 days. The growth of evaluation (2+) and evaluation (3+) was observed after the incubation for 10 days and 14 days, respectively. The growth area of fungi at the incubation period for 14 days was at most ⅓ of the area of the sample fabric

### (Evaluation Result on Antifungal Effect 2)

When a suspension of Aspergillus niger spores (6.6×10⁴) were sprayed on a standard cotton fabric not processed and cultured at 27±1° C. for 18 hours, the number of living fungi was 2.7×10⁴. In this test condition, in the sample fabric impregnated with the titanium-composed aqueous composition 2 (Example 3), the number of living fungi after incubation was 5.2×10³. The proliferation of Aspergillus niger (black koji fungus) was strongly suppressed (about ⅕) in the presence of the titanium-composed aqueous composition 2 of the present invention.

### INDUSTRIAL APPLICABILITY

The present invention can provide an aqueous composition capable of exhibiting high deodorant, antimicrobial and antifungal effects continuously by comprising aluminum, iron and potassium, and preferably titanium. Further, regarding the aqueous composition of the present invention, the content is adjusted, other agents are composed or suitable additives can be added, depending on a place in use and conditions of use. The effects of the present invention can be enhanced additively or synergistically by composing the above-mentioned other agents, for example, other deodorant, antimicrobial or antifungal agent.

1. An aqueous composition comprising a metal composition comprising iron, aluminum and potassium, and water.

2. The aqueous composition of claim 1, further comprising tetrahydroxytitanium hydrochloride.

3. The aqueous composition of claim 1, wherein the contents of aluminum and potassium are 100-300 ppm and 1-20 ppm, respectively, relative to 100 ppm of iron.

4. The aqueous composition of claim 2, wherein the content of titanium is 0.2-50 ppm relative to 100 ppm of iron.

5. A deodorant comprising the aqueous composition of claim 1.

6. An antimicrobial agent comprising the aqueous composition of claim 1.

7. An antifungal agent comprising the aqueous composition of claim 1.

8. The aqueous composition of claim 2, wherein the contents of aluminum and potassium are 100-300 ppm and 1-20 ppm, respectively, relative to 100 ppm of iron.

9. A deodorant comprising the aqueous composition of claim 2.

10. A deodorant comprising the aqueous composition of claim 3.

11. A deodorant comprising the aqueous composition of claim 4.

12. An antimicrobial agent comprising the aqueous composition of claim 2.

13. An antimicrobial agent comprising the aqueous composition of claim 3.

14. An antimicrobial agent comprising the aqueous composition of claim 4.

15. An antifungal agent comprising the aqueous composition of claim 2.

16. An antifungal agent comprising the aqueous composition of claim 3.

17. An antifungal agent comprising the aqueous composition of claim 4.
